(19) United States
(12) Patent Application Publication
(10) Pub. No.: US 2005/0042144 A1
(43) Pub. Date: Feb. 24, 2005

(54) Portable insulated container for biological specimens

(76) Inventor: A. Robert Hubbard, Onalaska, WI (US)

Correspondence Address: Christopher R. Christenson;Westman, Champlin & Kelly, Suite1600, 900 Second Avenue South, Minneapolis, MN, 55402-3319, US

(21) Appl. No.: 10/919,739

(22) Filed: Aug. 17, 2004

Related U.S. Application Data
(60) Provisional application No. 60/495,941, filed on Aug. 18, 2003.
(60) Provisional application No. 60/591,427, filed on Jul. 27, 2004.

(51) Int. Cl. B01L 3/00

(52) U.S. Cl. 422/102

(57) ABSTRACT

A portable biological insulated container includes a top portion and a bottom portion. Each of the top and bottom portion includes an interior chamber filled with a thermally insulative material. The bottom portion includes an inner and outer wall that are coupled together to form a double-walled configuration. At least one of the top portion and the bottom portion are adapted to be secured to the other.

### CROSS REFERENCE TO CO-PENDING APPLICATION

The present application claims priority to U.S. provisional patent applications: Ser. No. 60/495,941, filed Aug. 18, 2003, entitled “PORTABLE INSULATED CONTAINER FOR BIOLOGIC SPECIMENS”; and Ser. No. 60/591,427, filed Jul. 27, 2004, entitled “PORTABLE INSULATED CONTAINER FOR BIOLOGIC SPECIMENS”.

### BACKGROUND OF THE INVENTION

Housing, storing and/or protecting biological specimens such as bone marrow, blood and amniotic fluids is extremely important in the medical industry. As used herein, “biological specimens” is intended to mean any substance grown, or otherwise produced, by a human or animal. Such biological specimens can be damaged, or destroyed due to exposure to extreme temperatures. Such samples are extremely temperature sensitive. For example, biological specimens can easily be damaged or destroyed if the specimen freezes during transit to a reference laboratory for testing. Allowing the sample to freeze during transport by the courier, easily render the sample useless. During cold weather, dangerously cold temperatures can penetrate into a standard shipping box or styro during transit or during transportation delays. Often, during flight-related delays, medical packages may be left exposed on an airport tarmac, in an unprotected cargo port, or in a unheated vehicle for hours. If it is cold enough, and the packages exposed for too long, the cold will penetrate inside the shipping container and damage the biological specimens.

Not only is it important to protect the biological specimens from exposure to deleterious temperatures, it is also important to physically protect the biological specimens. While reference laboratories often use quality-shipping boxes with Styrofoam to send their medical samples, there are often times when the Styrofoam and box are simply not enough to prevent a critical bone marrow or blood sample from freezing and being rendered useless for testing. Providing additional physical and thermal protection for such samples would address such situations where critical temperature sensitive biological specimens are subjected to thermal extremes and/or physical shock.

### SUMMARY OF THE INVENTION

A portable biological insulated container includes a top portion and a bottom portion. Each of the top and bottom portion includes an interior chamber filled with a thermally insulative material. The bottom portion includes an inner and outer wall that are coupled together to form a double-walled configuration. At least one of the top portion and the bottom portion are adapted to be secured to the other.

### BRIEF DESCRIPTION OF THE DRAWINGS

FIG. 1 is a cross sectional elevation view of a portable insulated container for biological specimens in accordance with an embodiment of the present invention.

FIG. 2 is a top bottom plan cross section taken along lines A-A of FIG. 1.

FIG. 3 is a cross sectional view of a portable insulated container for biological specimens in accordance with another embodiment of the present invention.

FIG. 4 is a diagrammatic view of creation of a double-walled bottom portion in accordance with an embodiment of the present invention.

FIG. 5 is a front elevational cross section view of a portable insulated container for biological specimens in accordance with an embodiment of the present invention.

FIG. 6 is a perspective view of a portable insulated container for biological specimens in accordance with an embodiment of the present invention.

### DETAILED DESCRIPTION OF THE PREFERRED EMBODIMENTS

Embodiments of the present invention generally include main two protective and insulating vessel walls. An insulating material is disposed between the insulating vessel walls. Embodiments of the present invention generally include a top portion and a bottom portion, both of which are thermally insulated.

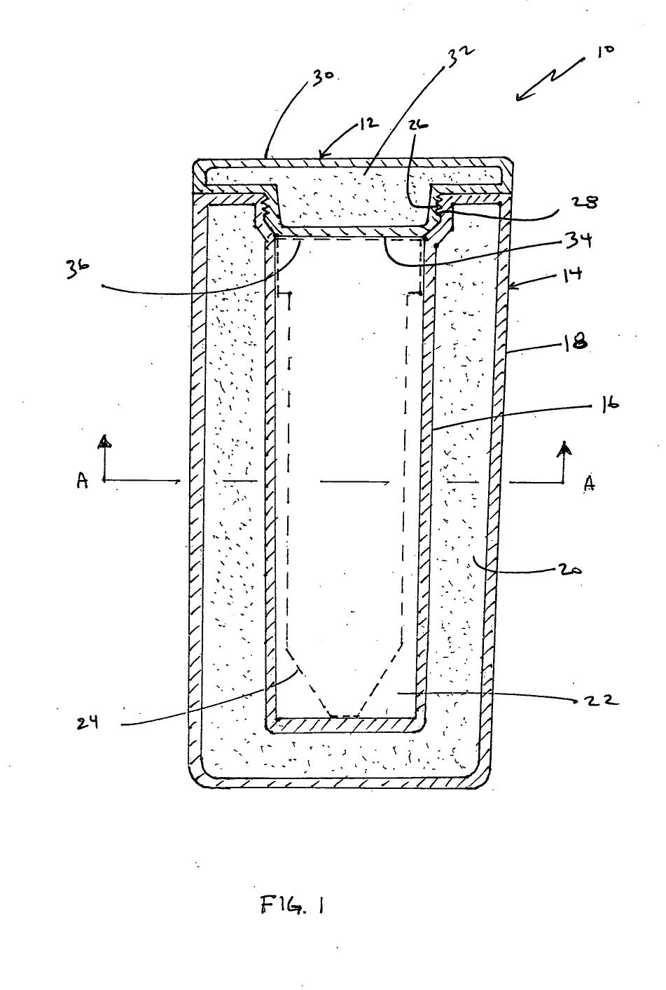

FIG. 1 is a cross sectional elevation view of a portable insulated container for biological specimens in accordance with an embodiment of the present invention. Container 10 includes top portion 12 and bottom portion 14, which are coupled to one another in preferably a threaded arrangement. Bottom portion 14 comprises protective and insulating walls 16 and 18, which are separated by an intermediate cavity 20. Inner vessel wall 16 defines an inner cavity 22 that is sized to receive a container such as a vial 24 (illustrated in phantom) or test tube carrying a biological specimen such as blood. In use, vial 24 is placed inside cavity 22 and top portion 12 is secured to bottom portion 14. Securing top portion 12 to bottom portion 14 is preferably accomplished by engaging threads 26 on top portion 12 with threads 28 in bottom portion 14. As illustrated in FIG. 1, threads 26 includes external threads that cooperate with internal threads 28 in bottom portion 14. Those skilled in the art will recognize that top portion 12 can alternatively include internal threads that cooperate with external threads provided on bottom portion 14.

Inner vessel wall 16 provides protection against shock from transport and is also constructed from a material that provides thermal insulation. In a preferred embodiment, vessel walls 16 and 18 are each constructed from polyethylene. Further, top portion 12 preferably includes wall 30 that is also preferably formed on polyethylene. In accordance with one embodiment of the present invention, chamber 22 is rendered air tight when top portion 12 is secured to bottom portion 14. This air-tight seal provides the additional function of isolating and containing the biological specimen within vial 24 should vial 24 break or leak.

In order to increase the thermal insulating properties of container 10, cavity 20 is preferably filled with an insulative material. More preferably, cavity 10 is filled with a thermally insulative solid material, or at least a material that cures to a solid. One preferable example of thermally insulative material suitable for provision in cavity 20 is polyurethane. The insulative material disposed within cavity 20 can be in solid, liquid or gas form such as sodium acetate, glycol alcohol, water, polymer, air and silicon-based compounds (gel). Cavity 20 can also be maintained at a vacuum.

Top portion 12 defines a cavity 32 that is preferably filled with the same insulative material as that provided in cavity 20. Additionally, lid 12 also preferably includes a bottom surface 34 that serves both as a plug and as an insulator. Bottom surface 34 of lid 12 is sized and/or shaped to be disposed proximate the top surface 36 of vial 24 when lid 12 is secured to bottom portion 14. This ensures that vial 24 is securely maintained within cavity 22 and also insulates the top of cavity 22 from the outside.

The outer surface of wall 18 and/or wall 30 preferably includes alphanumeric indicia. Preferably, the alphanumeric indicia on the portable container are created such the indicia will survive repeated sterilization cycles. One manner in which alphanumeric indicia can be exposed on the container is to physically raise the lettering from the surface of the container, or imprint the lettering therein. In embodiments where the top portion or bottom portion is cast of a polymeric material, such as polyethylene, the provision of raised or lower lettering is easily done by simply adapting the mold. Another way that alphanumeric indicia can be disposed on the container is by applying a polymeric graphic directly to the container. A polymeric graphic can according be molded into the container by applying a suitable heat treatment to cause the polymer of graphic to bond or otherwise fuse to the container.

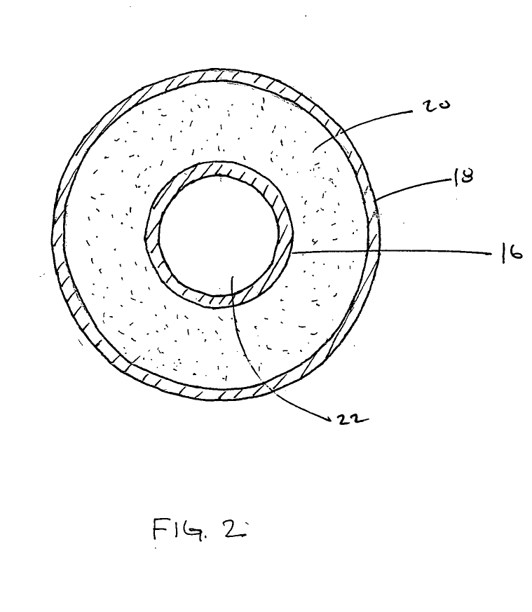

FIG. 2 is a cross sectional view of container 12 taken along section lines A-A in FIG. 1. FIG. 2 simply illustrates an embodiment wherein container 12 is shaped generally cylindrically. Accordingly, inner wall 16 and outer wall 18 are circular in shape. Cavity 20 is thus disposed between protective walls 16 and 18.

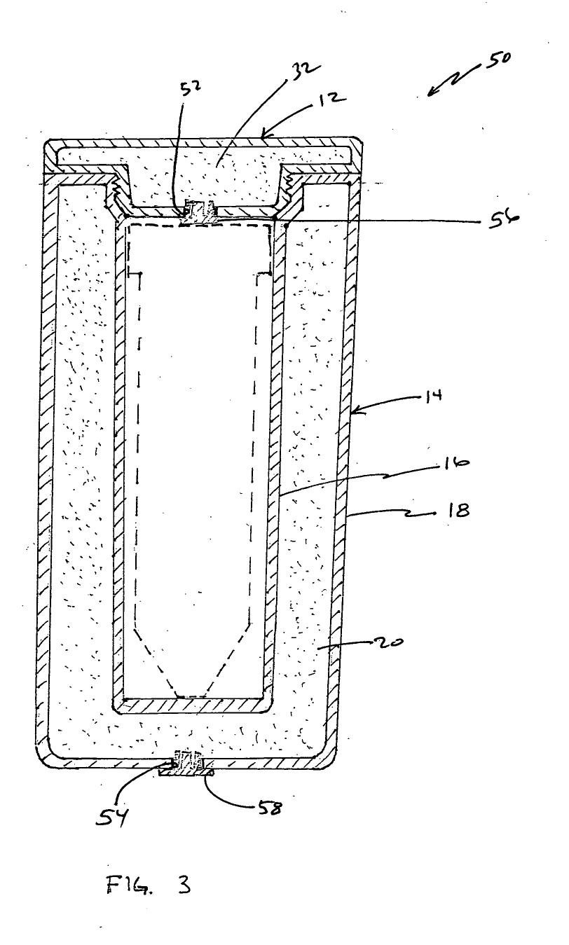

FIG. 3 is a cross sectional view of a portable insulated container for biological specimens in accordance with another embodiment of the present invention. Container 50 has many similarities to container 10 illustrated with respect to FIGS. 1 and 2, and like components are numbered similarly. Container 50 differs from container 10 because each of top portion 12 and bottom portion 14 defines holes 52, 54, respectively. Holes 52, 54 are illustrated as capped with plugs 56, 58, respectively. Other forms of sealing holes 52, 54 are contemplated within the scope of the present invention. The arrangement illustrated in FIG. 3 allows the insulative material in cavities 20 and 32 to be injected, or otherwise inserted, after the walls defining top portion 12 and bottom portion 14 have been created. The arrangement is particularly advantageous in embodiments where each of top portion 12 and bottom portion 14 are formed by joining two pieces together.

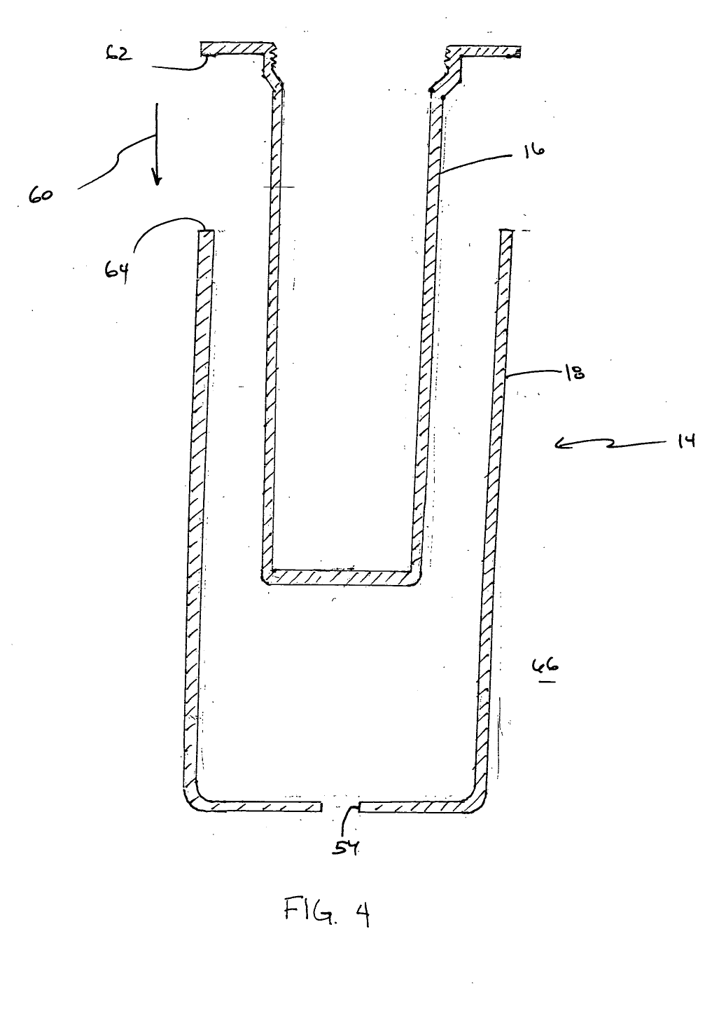

FIG. 4 is a diagrammatic view of bottom portion 14 being formed by joining inner wall 16 you outer wall 18. Inner wall 16 is displaced in the direction of arrow 60 until surface 62 of inner wall 16 is brought into contact with surface 64 of outer wall 18. Once surface is 62 and 64 are brought together, they are bonded using any appropriate techniques, including adhesives, polymeric welding techniques, fusion bonding, or any other suitable methods. The result of bonding surfaces 62 and 64 together is the creation of chamber 20. Cavity 20 is only in fluidic communication with exterior 66 via hole 54. This manufacturing technique allows simplified casting, or other manufacturing techniques to be used in the creation of simplified shapes defined by the two half pieces/walls 16 and 18. Preferably, top portion 12 (shown in FIGS. 1 and 3) is formed in a similar manner.

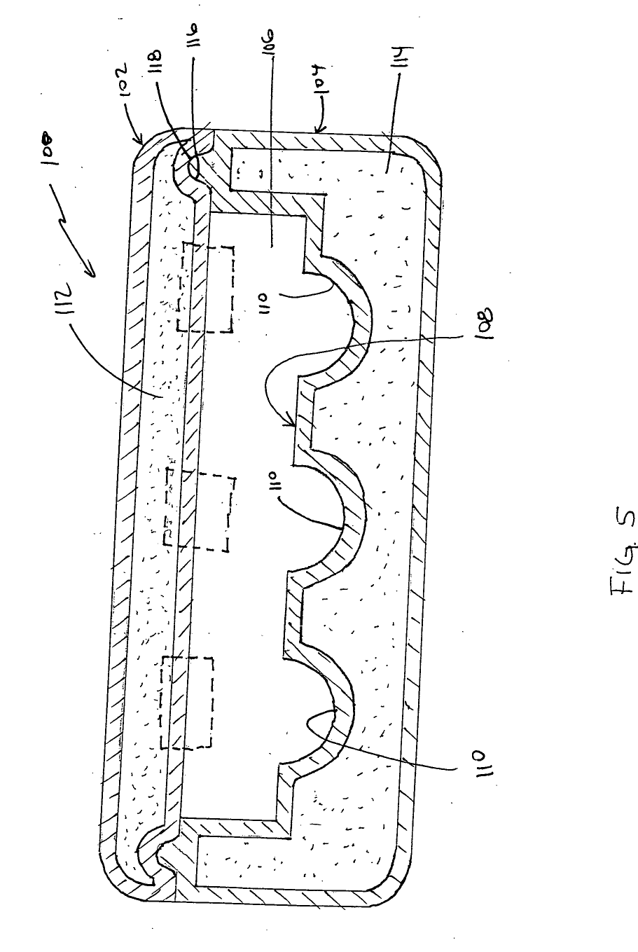

FIG. 5 is a cross section elevational view of portable insulative container 100 for biological specimens in accordance with an embodiment of the present invention. Container 100 includes top portion, or lid 102 and bottom portion 104. A chamber 106 is defined between top portion 102 and bottom portion 104. Chamber 106 is sized to receive a plurality of specimens. In one embodiment, chamber 106 has a bottom surface 108 that is shaped to receive a biological specimen-containing vial or test tube. The vial or test tube will rest in circular grooves 110. The shaping of surface 108 to conform to test tubes, or vials, is exemplary, and embodiments of the present invention can also be practiced when surface 108 is simply flat. Each of top portion 102 and bottom portion 104 are of double-wall construction defining insulative cavities 112 and 114 therein, respectively. An insulative material, preferably polyurethane, is disposed within each of cavities 112 and 114. As illustrated in FIG. 5, bottom portion 104 preferably includes a ridge 116 that is shaped to cooperate with a corresponding groove 118 in top portion 102. The cooperation of ridge 116 and groove 118 help form an airtight seal within chamber 106. Each of ridge 116 and groove 118 may be formed of materials that facilitate an airtight seal. For example, ridge 116 and/or groove 118 may be formed, at least in part, of an elastomeric material.

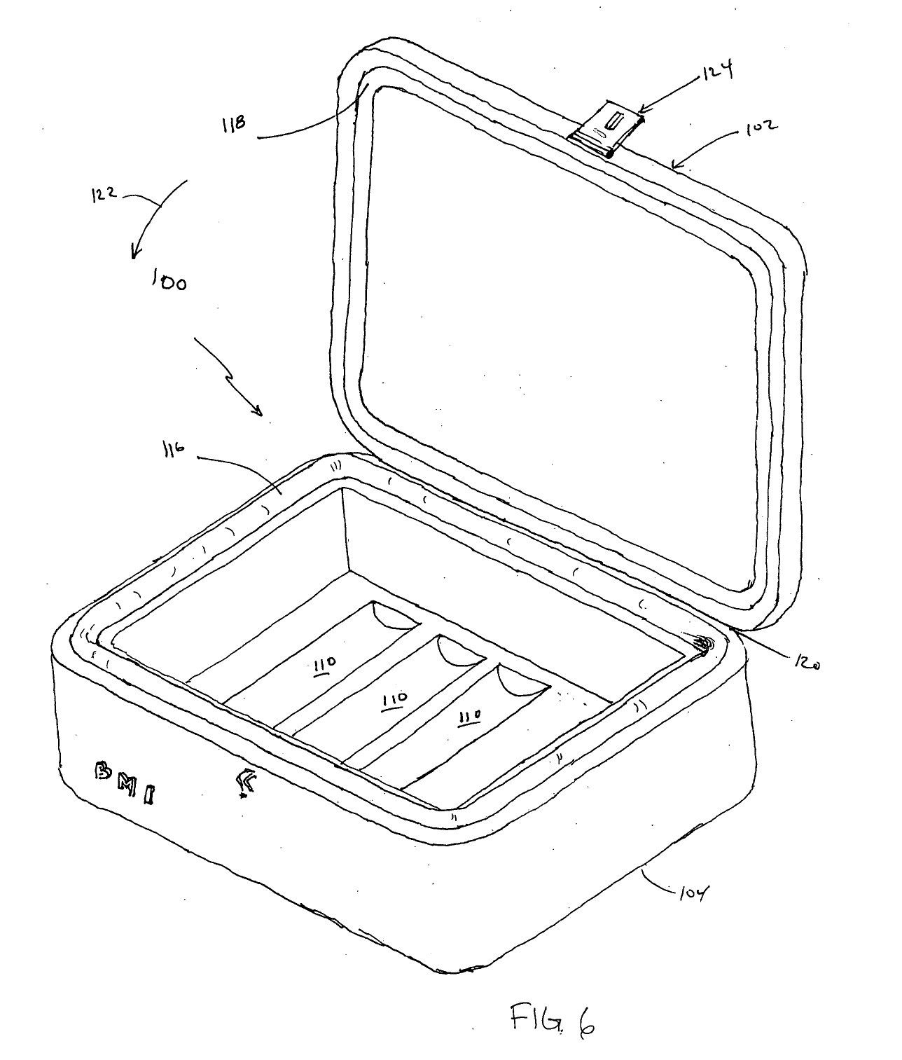

FIG. 6 is a perspective view of container 100 in accordance with an embodiment of the present invention. As illustrated in FIG. 6, top portion 102 is preferably hingedly connected to bottom portion 104 at inner face 120. When so connected, top portion 102 can be closed and secured upon bottom portion 104 by moving in a direction of arrow 122. A mechanism 124 is preferably included for securing lid 102 to bottom portion 104 when it is fully closed upon portion 104. Securing mechanism 124 can be in the form of a clasp, clip, hook, or any other suitable device for securing top portion 102 to bottom portion 104.

The portable insulated containers in accordance with embodiments of the present invention, generally provide an inner and outer wall that is essentially one piece and provides structural stability during exposures to temperatures from vary cold (−60° F.—dry ice during mishandling) to very hot (in excess of 180° F.—for sterilization). The cavities between inner and outer walls in the bottom portions and top portions are insulated to provide thermal insulation to the biological specimens in all directions. The top portions are preferably sealed to the bottom portions provide an air-tight seal to prevent cold from seeping therein, and also to seal the biological sample within in the container. The interior space of the portable container is sized to provide for the placement of one or more test tubes, centrifuge tubes and other containers specifically designed to hold human or animal biological samples for medical reference laboratory industry. When biological specimens are disposed within containers in accordance with embodiments of the present invention, additional thermal and physical protection is provided by placing the container within a conventional Styrofoam container.

Although the present invention has been described with reference to preferred embodiments, workers skilled in the art will recognize that changes may be made in form and detail without departing from the spirit and scope of the invention.

1. A portable insulated container for biological specimens, the container comprising:
a top portion having a first cavity therein, the first cavity adapted to be thermally insulative;
a bottom portion having an interior wall defining a specimen-receiving cavity, an outer wall coupled to the inner wall defining a second cavity therein, the second cavity being adapted to be thermally insulative; and
wherein the top portion is coupleable to the bottom portion to seal the specimen-receiving cavity.

2. The container of claim 1, wherein at least one of the first and second cavities includes an insulating material.

3. The container of claim 2, wherein the insulating material is a liquid.

4. The container of claim 2, wherein the insulating material is a gel.

5. The container of claim 2, wherein the insulating material is a solid.

6. The container of claim 5, wherein the insulating material is polyethylene.

7. The container of claim 1, wherein both of the first and second cavities includes an insulating material.

8. The container of claim 7, wherein the insulating material is a liquid.

9. The container of claim 7, wherein the insulating material is a gel.

10. The container of claim 7, wherein the insulating material is a solid.

11. The container of claim 10, wherein the insulating material is polyethylene.

12. The container of claim 1, wherein the inner wall is joined to the outer wall at an interface.

13. The container of claim 12, wherein the outer wall includes a hole to allow insulating material to be inserted into the second cavity.

14. The container of claim 13, and further comprising a plug sized to plug the hole.

15. The container of claim 1, wherein the top portion is formed of two pieces joined together.

16. The container of claim 15, wherein the top portion includes a hole to allow insulating material to be inserted into the first cavity.

17. The container of claim 1, wherein the container is shaped as a cylinder.

18. The container of claim 1, wherein the container is shaped rectangularly.

19. The container of claim 18, wherein the specimen-receiving cavity is sized to receive a plurality of specimens.

20. The container of claim 19, wherein the bottom portion includes a bottom surface is shaped to receive the plurality of specimens.

21. The container of claim 18, wherein the top portion is hingedly coupled to the bottom portion.

22. The container of claim 18, and further comprising a securing mechanism that secures the top portion and bottom portion together.

23. The container of claim 18, wherein the bottom portion includes a ridge facing the top portion.

24. The container of claim 23, wherein the top portion includes a groove sized to cooperate with the ridge to seal the specimen-receiving container when the top portion is secured to the bottom portion.

25. The container of claim 24, wherein at least one of the ridge and the groove is formed, at least in part, of an elastomer.

26. The container of claim 1, and further including indicia disposed on the container.

27. The container of claim 26, wherein the indicia is molded into the container.

28. The container of claim 27, wherein the indicia comprises raised lettering.

29. The container of claim 27, wherein the indicia is molded to the container by heat treating a polymeric graphic to the container.

30. A method of protecting a biological specimen, the method comprising:
placing the specimen in a double-walled insulative container; and
forming an air-tight seal within the container; and
placing the container in a Styrofoam container.
